(19) United States
(12) Patent Application Publication
(10) Pub. No.: US 2010/0162205 A1
(43) Pub. Date: Jun. 24, 2010

(54) APPARATUS AND METHOD FOR AUTOMATICALLY GENERATING CAPABILITY STATEMENTS FOR MANAGEMENT INTERFACES

(75) Inventors: L. Alexander Clemm, Los Gatos, CA (US); Steven Howard Berl, Piedmont, CA (US); Edwin Mach, San Jose, CA (US); Jerome Jabson, South San Francisco, CA (US)

Correspondence Address: SCHWEGMAN, LUNDBERG & WOESSNER, P.A., P.O. BOX 2938, MINNEAPOLIS, MN, 55402, US

(73) Assignee: Cisco Technology, Inc., san jose, CA (US)

(21) Appl. No.: 12/343,309

(22) Filed: Dec. 23, 2008

(51) Int. Cl. G06F 9/44

(52) U.S. Cl. 717/106

(57) ABSTRACT

Various embodiments provide an apparatus and method for automatically generating capability statements for management interfaces. An example embodiment includes obtaining an external interface definition defining an external interface; obtaining an internal interface definition defining an internal interface; obtaining a mapping between elements of the external interface and the corresponding elements of the internal interface; obtaining an internal interface compliance statement including compliance information related to the internal interface; and automatically generating an external interface capability statement based on the external interface definition, the internal interface definition, the mapping, and the internal interface compliance statement.

### FIELD

The disclosed subject matter relates to the field of data processing devices, and more particularly to networked data processing devices.

### BACKGROUND

In modern embedded architectures, it can be beneficial to separate the instrumentation of a feature itself, as exposed through an internal application programming interface (API), from the implementation of management agents that expose management interfaces. Feature instrumentation can be developed once and ideally provides a single embedded management interface (e.g., an API) according to an embedded interface definition (i.e., a formal interface specification). Management agents that implement management interfaces, such as the Simple Network Management Protocol (SNMP), which use a computing information repository, such as Management Information Bases (MIB's) or command line interface (CLI) commands, are implemented by mapping the management requests to invocations on the API, and reversely mapping the output parameters and return codes to management responses. For some interfaces, this mapping occurs in a data-driven way. The mapping is defined as its own specification, which is interpreted by an engine that is part of the agent implementation.

One example of a management interface for which such a mapping can be defined is SNMP and the MIBs that are accessed through SNMP. In another example of a management interface, Netconf or other XML-based management interfaces and the associated XML data models can be used. This management interface, provided by the management agent, is subjected to testing, and a capability report, or statement, is generated outlining exactly which parts of the interface definition are supported. Capability statements are used to indicate the precise level of support that the provider of an interface provides with respect to a management interface specification, for example a specification of an MIB exposed through SNMP, or of an XML data model exposed through Netconf or another XML-based management interface. A network management system (NMS) can adjust its behavior toward agents according to the capabilities statements associated with each agent.

Systems whose internal features and applications provide a programming interface that is driven by management agent implementations need to provide a capability statement for the internal API definition, in addition to the capability statements for each of the external management interfaces. This facilitates the development of management agents on top of that API and reuse of the same mappings on multiple platforms. In general, this involves a second round of capability testing. At the same time, some (external) management interfaces are derived algorithmically from the embedded management interface definition. This is the case for the Extensible Markup Language (XML) Data Model to be exposed across XML Programmable Interface or Netconf agents. Prior systems have also considered how to generate a set of synthetic MIB's, reflecting the underlying embedded management interface definition. Those synthetic MIB's are not intended to replace the existing MIB's, many of which have been standardized by the IETF as Request For Comments (RFC's), but to complement them by achieving more complete coverage of the various control mechanisms inherently present in a router, for example. With the current momentum to make any management information accessible over any management protocol, we expect the demand for synthetically generated management interfaces will increase.

### BRIEF DESCRIPTION OF THE DRAWINGS

FIG. 1 illustrates a data-driven management agent implementation in an example embodiment.

FIG. 2 illustrates an example embodiment for the generation of synthetic capability statements.

FIG. 3 illustrates an example embodiment of the synthetic capability statement generator.

FIG. 4 is a flow diagram illustrating the processing flow for a particular example embodiment.

FIG. 5 illustrates an example of a computing system on which processing for various embodiments can be implemented.

### DESCRIPTION OF EXAMPLE EMBODIMENTS

In the following detailed description, reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

### Overview

Various example embodiments described herein include systems and methods for the automatic or synthetic generation of management interface capability statements, without needing to subject the management interface to actual testing. An example embodiment of the system and method is implemented using a definition of a mapping of a management interface to an underlying management interface, without needing to subject the management interface to testing.

### Example Embodiments

A major new trend among network equipment providers is to open up network equipment platforms and make them programmable and extensible. Eventually, the new features and functions that will be developed as a consequence will need to be managed themselves, separately from managing the underlying platform. The new features and functions will need to be configured and monitored, and statistics unique to those applications will need to be maintained. Platforms that not only allow customers to develop applications on top, but also allow those applications to be managed in an integrated fashion, will have an benefits over platforms not capable of offering such capabilities. As part of opening up platforms for customers, software development kits (SDK's) need to be offered to customers and third parties to allow them to integrate the new applications with the platform on top of which the new applications are running. These SDK's need to address the manageability of the application, i.e., how to integrate management of the new application with management of the platform as a whole. It is highly desirable to be able to manage the entire network element as one unit, through an integrated CLI, a single SNMP agent, etc. One way to accomplish this goal is through the architecture of the various embodiments described herein.

To be managed properly, the new application needs to provide an embedded instrumentation interface that is defined and developed by the application developer. This is the “underlying or internal interface” as described herein. In addition, the new application also needs to provide a collection of management interfaces used to communicate with external management applications. Those management interfaces are provided by management agents, which mediate between the external management interface—or management protocol—and the internal underlying interface—or application APIs. The management agents (e.g., SNMP, CLI, etc.) of the hosting platform are ideally data driven. Thus, the application developer will also provide a mapping file that defines how to map elements (e.g., a management request or MIB object) of the external management interface to corresponding elements of the underlying (internal) interface. The mapping file can be interpreted by the agent (i.e., the management agent that provides the external management interface). Therefore, to allow for management, the application developer needs to provide three things: 1) the embedded instrumentation (internal) interface through which the application is managed; 2) the external management interface exposed through one or more management agents—one such management agent can expose XML-based data models, such as those that can be used in conjunction with NETCONF (the NETCONF protocol providing mechanisms to install, manipulate, and delete the configuration of network devices) or SNMP; and 3) a mapping file that defines how to translate between the two interfaces. Note that there can be one or more mapping files that correspond to one or more agents and one or more management interfaces.

The SDK can facilitate these tasks by requiring the developer to simply develop the embedded instrumentation (internal) interface, then automatically derive a corresponding XML-based data model from the instrumentation (internal) interface and automatically generate the corresponding mapping file. A developer could develop additional mapping files for other management interfaces, such as CLI. Now, in addition to the management instrumentation itself, a capability and/or capability statement for each of those external management interfaces (one for the MIB, one for the XML data model, one for the CLI, etc.) will need to be provided. The SDK used by the application developer/customer/third party should ideally support the creation of such capability statements. The various embodiments described herein enable and automate the generation of the capability statements for these external management interfaces. In conventional systems, the generation of the capability or capability statements for the external management interfaces would require separate testing for each external management interface. In contrast, with the various embodiments described herein, it is sufficient to subject only the internal interface to testing.

As described further below, according to various example embodiments, there is provided an apparatus and method for automatically generating capability statements for management interfaces. An example embodiment is described wherein the data driven aspect of the management interface implementation is exploited. The embodiment uses a mapping file associated with the underlying (internal) interface for which a capability report is already available. One important idea behind the embodiment is that if a file containing a definition of a mapping can be used to automatically implement a management interface through an engine interpreting that mapping, then the same mapping definition can be used to automatically derive the capability report for that interface, given a capability report for the underlying interface that is being mapped. It can be safely assumed that the mapping itself is correct. This can be safely assumed, for example, in scenarios in which the management interface itself is synthetic and was generated from the definition of the underlying interface, along with the mapping file itself. There are other scenarios as well; for example, there are cases in which the mapping definition has been tested for another platform or for another implementation of the same internal API.

A particular example embodiment described herein can automatically generate capability statements for management interfaces using the following processing operations. The particular embodiment can use a set of inputs that include: (a) a definition of the target external management interface, such as a MIB definition; (b) a definition of the underlying internal system interface, i.e., the definition of the interface of the instrumented component; (c) a capability report for the internal interface of the instrumented feature; and (d) a mapping file, formally describing how management operations and management information of the target external interface map onto the elements of the underlying internal feature instrumentation interface. Using these inputs, a particular embodiment can produce an output. The output can include a capability statement for the target external management interface. The output can be produced in the following manner: for each artifact of the target external management interface, the mapping file is used to locate the artifact of the underlying internal instrumentation interface to which the artifact of the target external management interface is mapped. If the input capability report indicates that the internal instrumentation interface complies with each of the artifacts of the external management interface that are utilized in the mapping, the artifact of the target external management interface is marked as compliant. Otherwise, the artifact of the target external management interface is marked as non-compliant. The various embodiments described herein can effectively eliminate the test effort associated with synthetic management interfaces, making providing such interfaces that provide complete coverage an even more viable option.

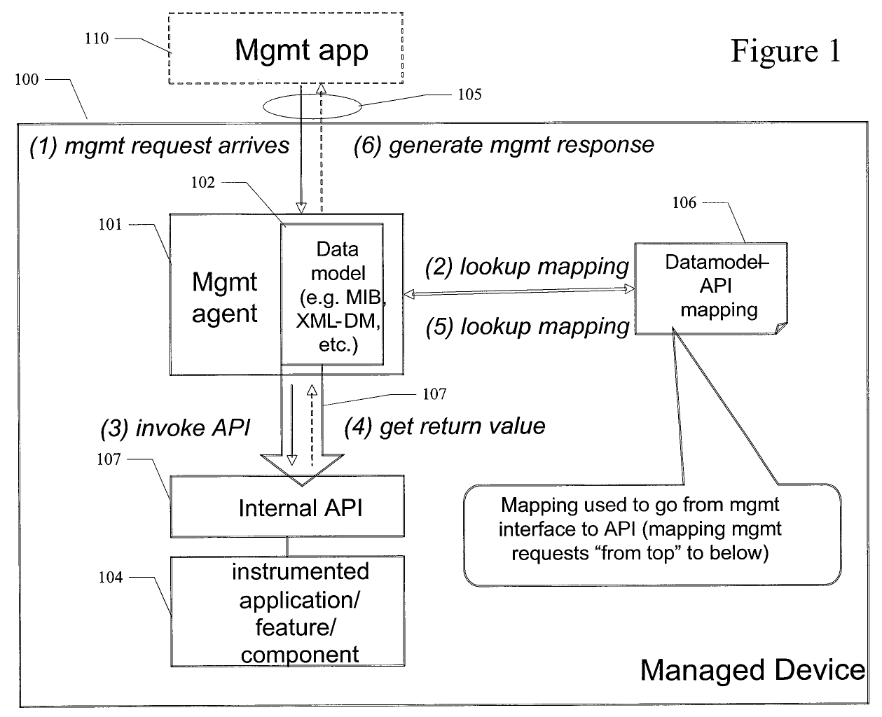

FIG. 1 illustrates a data-driven management agent implementation in an example embodiment. A managed device 100 is shown in data communication with an external management application 110. This data communication may occur via conventional network protocols, such as those used on the Internet. The data communication between the external management application 110 and the managed device 100 can also conform to a pre-defined application interface specification. This interface can be denoted as the external management interface 105, because this interface is exposed to systems outside of or external to the managed device 100 through the management agent 101. One such management agent 101 can expose XML-based data models, such as those that can be used in conjunction with NETCONF (The NETCONF protocol provides mechanisms to install, manipulate, and delete the configuration of network devices, for example). The external management interface 105 is typically a well-established and thoroughly tested interface; however, some managed devices 100 may not support portions of the external management interface 105. The capability report for the external management interface 105 is used to specify which portions of the external management interface 105 are/are not supported. Using the functionality described herein, this capability report for the external management interface 105 can be automatically generated.

Referring again to FIG. 1, the management agent 101 includes a data model 102 (e.g., XML-based data models), which can be used to manage and/or configure a managed device 100. The data model 102 can be used in conjunction with a data model map or mapping 106 to form relationships between (or define a mapping between) an artifact of the external management interface 105 and the corresponding artifact of the internal or embedded device interface 107. For example, the data model mapping 106 can be used to associate a request made by an external management application 110 via the external management interface 105 with a corresponding call of the internal or embedded device interface 107. Note that in other embodiments, there can be a plurality of management agents 101, each with its own data model mapping 106 and each requiring its own capability statement.

As shown in FIG. 1, in a first operation (1) of a sequence of operations, a management request can be received at the managed device 100 via the external management interface 105. In a second operation (2) of the sequence of operations, the received management request can be used by the management agent 101 to perform a look-up operation in data model mapping 106 to find the artifact of the internal interface 107 that corresponds to the received management request. In a third operation (3) of the sequence of operations, the management agent 101 can use the corresponding artifact of the internal interface 107 to invoke the portion of the internal interface 107 that corresponds to the received management request. This invocation of the internal interface 107 can cause the instrumented component 104 of the managed device 100 to generate an output. In a fourth operation (4) of the sequence of operations, the management agent 101 can obtain the output generated by the instrumented component 104. In a fifth operation (5) of the sequence of operations, the received output of the instrumented component 104 can be used by the management agent 101 to perform a look-up operation in data model mapping 106 to find the artifact of the external management interface 105 that corresponds to the received output. In a sixth operation (6) of the sequence of operations, the management agent 101 can generate a response to the external management application 110 via the corresponding artifact of the external management interface 105 that corresponds to the mapped output from the instrumented component 104. In this manner, a request from an external management application 110 is received by a managed device 100, mapped between an external management interface 105 and an internal interface 107, processed at the managed device 100 using the internal interface 107 and delivered to the external management application 110 using the external management interface 105.

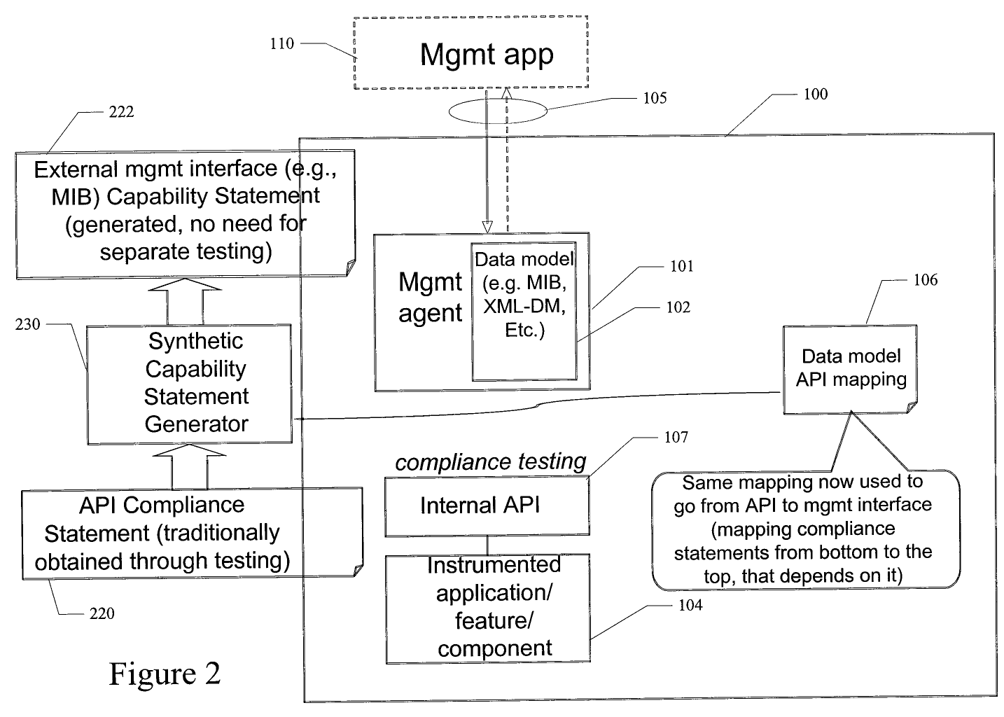

FIG. 2 illustrates an example embodiment for the generation of synthetic capability statements. The external management interface 105 is typically a well-established and thoroughly tested interface; however, some managed devices 100 may not support portions of the external management interface 105. Thus, it is important to provide a capability statement corresponding to the external management interface 105 that defines the supported (or unsupported) portions of the external management interface 105. In conventional systems, these capability or capability statements had to be manually generated after expensive and time-consuming interface testing. The various embodiments described herein automate this process in a distinctive manner.

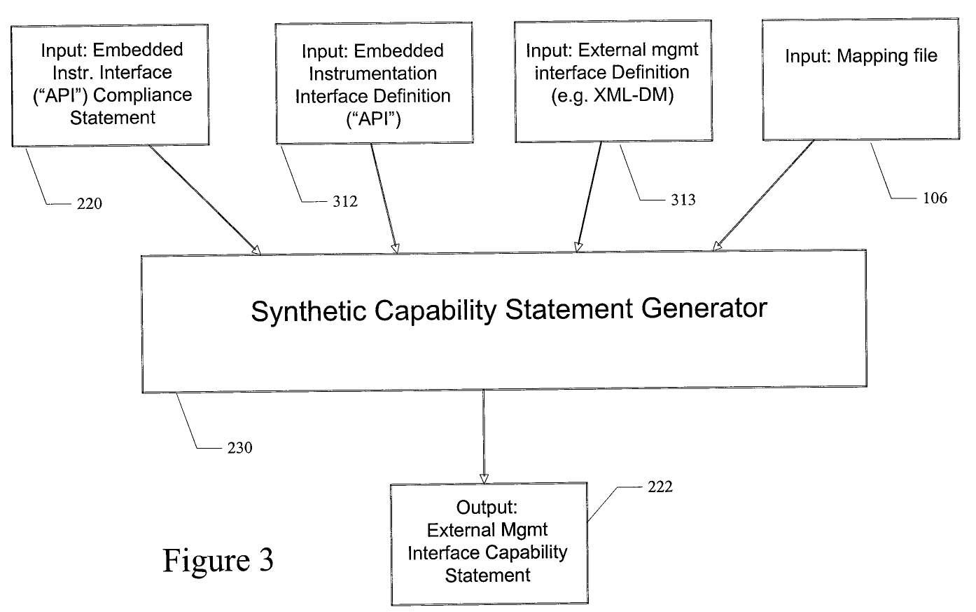

As shown in FIG. 2, the internal interface 107 of managed device 100 undergoes a rigorous level of capability testing prior to the release of the managed device 100 for public availability. As part of this capability testing, an internal interface compliance statement 220 associated with the internal interface 107 is generated. This internal interface compliance statement 220 defines the capabilities of the managed device 100 available via the internal interface 107. Given this internal interface compliance statement 220 and the data model mapping 106 defining a mapping between external management interface 105 artifacts and corresponding internal interface 107 artifacts, a synthetic capability statement generator 230 can produce an external management interface capability statement 222 that defines the capabilities of the managed device 100 available via the external management interface 105. This external management interface capability statement 222 for the external management interface 105 can be generated automatically and without separate testing. As such, the automatically generated capability statements for management interfaces are easily updated and less prone to errors than traditional methods. Thus, capability testing of the external management interface 105 is no longer needed Details of the synthetic capability statement generator 230 are illustrated in FIG. 3 and described below.

FIG. 3 illustrates an example embodiment of the synthetic capability statement generator 230. The synthetic capability statement generator 230 can receive several inputs, including an internal interface compliance statement 220, an internal interface definition 312 (e.g., an application programming interface—API definition) that defines the internal interface 107, an external interface definition 313 that defines the external management interface 105, and the data model mapping 106. As described above, the data model mapping 106 includes information that correlates or maps artifacts of the external management interface 105 defined by the external interface definition 313 with artifacts of the internal interface 107 defined by the internal interface definition 312. The internal interface compliance statement 220 provides interface capability information related to the internal interface 107 defined by the internal interface definition 312. Thus, using the interface capability information related to the internal interface 107 and the mapping of the external management interface 105 to the internal interface 107, capability statement generator 230 can correlate the interface capability information with the external management interface 105 to produce the external management interface capability statement 222. The external management interface capability statement 222 can thereby be automatically or synthetically generated without additional testing. The external management interface capability statement 222 enables an external management application 110 (shown in FIG. 2) to determine which parts of the external interface definition are supported.

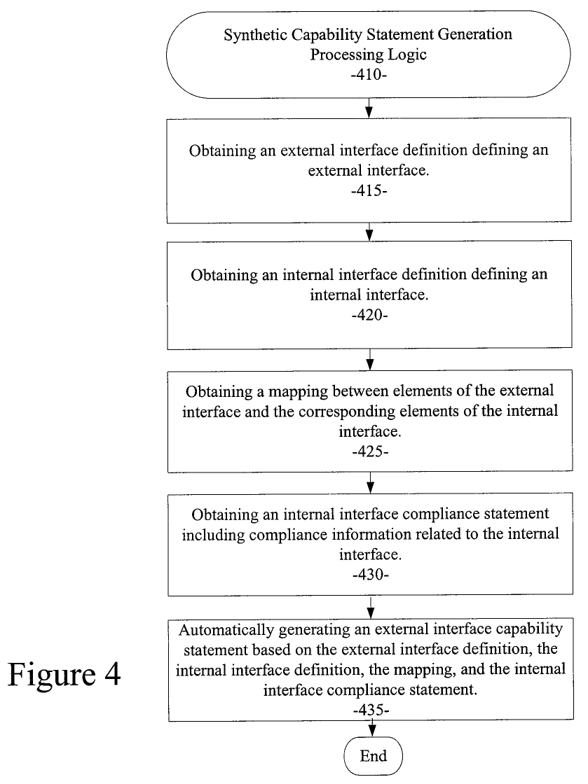

FIG. 4 illustrates a process flow diagram for an example embodiment. In the embodiment 410 shown, an apparatus and method for automatically generating capability statements for management interfaces includes: obtaining an external interface definition defining an external interface (processing block 415); obtaining an internal interface definition defining an internal interface (processing block 420); obtaining a mapping between elements of the external interface and the corresponding elements of the internal interface (processing block 425); obtaining an internal interface compliance statement including compliance information related to the internal interface (processing block 430); and automatically generating an external interface capability statement based on the external interface definition, the internal interface definition, the mapping, and the internal interface compliance statement (processing block 435).

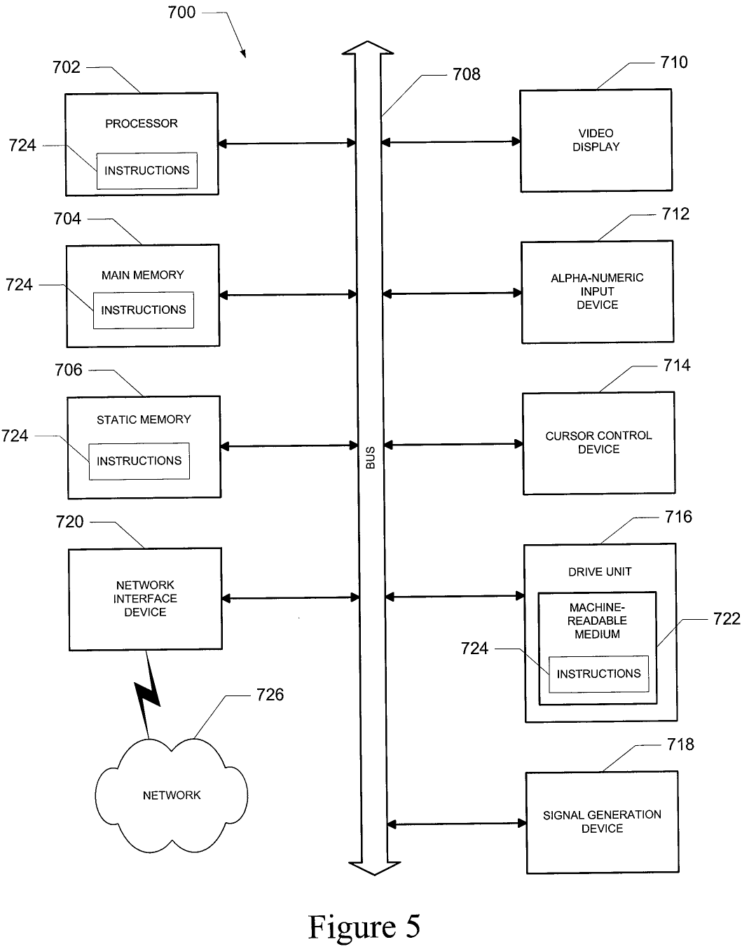

FIG. 5 shows a diagrammatic representation of a machine in the example form of a computer system 700 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software) 724 embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g., configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical and magnetic media, and carrier wave signals. As noted, the software may be transmitted over a network using a transmission medium. The term “transmission medium” shall be taken to include any medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

Although the present specification describes components and functions implemented in the embodiments with reference to particular standards and protocols, the disclosed subject matter may be not limited to such standards and protocols. Each of the standards for Internet and other packet-switched network transmission (e.g., transmission control protocol (TCP)/Internet Protocol (IP) (TCP/IP), User Datagram Protocol (UDP)/Internet Protocol (IP) (UDP/IP), Hypertext Markup Language (HTML), and Hypertext Transfer Protocol (HTTP)) represent examples of the state of the art. Such standards are periodically superseded by faster or more efficient equivalents having essentially the same functions. Accordingly, replacement standards and protocols having the same functions are considered equivalents.

Thus, as described above, an apparatus and method for automatically generating capability statements for management interfaces is disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

We claim:

1. A method comprising:
obtaining an external interface definition defining an external interface;
obtaining an internal interface definition defining an internal interface;
obtaining a mapping between elements of the external interface and corresponding elements of the internal interface;
obtaining an internal interface compliance statement including compliance information related to the internal interface; and
automatically generating an external interface capability statement based on the external interface definition, the internal interface definition, the mapping, and the internal interface compliance statement.

2. The method as claimed in claim 1 wherein the elements of the external interface include Management Information Bases (MIB) objects.

3. The method as claimed in claim 1 wherein the elements of the external interface include a management request.

4. The method as claimed in claim 1 wherein the external interface includes an XML-based data model.

5. The method as claimed in claim 1 wherein the internal interface is only exposed internally within a managed device.

6. The method as claimed in claim 1 wherein the external interface is exposed to a management application external to a managed device.

7. A synthetic capability statement generator comprising:
a first interface to receive an external interface definition defining an external interface, an internal interface definition defining an internal interface, a mapping between elements of the external interface and corresponding elements of the internal interface, and an internal interface compliance statement including compliance information related to the internal interface;
a processing component to automatically generate an external interface capability statement based on the external interface definition, the internal interface definition, the mapping, and the internal interface compliance statement; and
a second interface to output the external interface capability statement.

8. The synthetic capability statement generator as claimed in claim 7 wherein the elements of the external interface include Management Information Bases (MIB) objects.

9. The synthetic capability statement generator as claimed in claim 7 wherein the elements of the external interface include a management request.

10. The synthetic capability statement generator as claimed in claim 7 wherein the external interface includes an XML-based data model.

11. The synthetic capability statement generator as claimed in claim 7 wherein the internal interface is only exposed internally within a managed device.

12. The synthetic capability statement generator as claimed in claim 7 wherein the external interface is exposed to a management application external to a managed device.

13. An apparatus comprising:
means for obtaining an external interface definition defining an external interface;
means for obtaining an internal interface definition defining an internal interface;
means for obtaining a mapping between elements of the external interface and corresponding elements of the internal interface;
means for obtaining an internal interface compliance statement including compliance information related to the internal interface; and
means for automatically generating an external interface capability statement based on the external interface definition, the internal interface definition, the mapping, and the internal interface compliance statement.

14. The apparatus as claimed in claim 13 wherein the elements of the external interface include Management Information Bases (MIB) objects.

15. The apparatus as claimed in claim 13 wherein the elements of the external interface include a management request.

16. The apparatus as claimed in claim 13 wherein the external interface includes an XML-based data model.

17. The apparatus as claimed in claim 13 wherein the internal interface is only exposed internally within a managed device.

18. The apparatus as claimed in claim 13 wherein the external interface is exposed to a management application external to a managed device.

19. A system comprising:
a management agent to receive a first request via an external interface;
an instrumented component, coupled to the management agent, to receive a second request via an internal interface;
a mapping to map the first request to the second request; and
a synthetic capability statement generator to receive an external interface definition defining the external interface, an internal interface definition defining the internal interface, the mapping, and an internal interface compliance statement including compliance information related to the internal interface, the synthetic capability statement generator automatically generating an external interface capability statement based on the external interface definition, the internal interface definition, the mapping, and the internal interface compliance statement.

20. The system as claimed in claim 19 wherein elements of the external interface include Management Information Bases (MIB) objects.

21. The system as claimed in claim 19 wherein elements of the external interface include a management request.

22. The system as claimed in claim 19 wherein the external interface includes an XML-based data model.

23. The system as claimed in claim 19 wherein the internal interface is only exposed internally to the management agent.

24. The system as claimed in claim 19 wherein the external interface is exposed externally outside of the management agent.
